(19) United States
(12) Patent Application Publication
(10) Pub. No.: US 2026/0004033 A1
(43) Pub. Date: Jan. 1, 2026

(54) METHOD FOR ESTIMATING CIRCUIT PARAMETERS OF DAB CONVERTERS BASED ON PHYSICS-INFORMED NEURAL NETWORK

(71) Applicant: Zhejiang University, Hangzhou (CN)

(72) Inventors: Yongheng Yang, Hangzhou (CN); Tianjing Xie, Hangzhou (CN); Yinxiao Zhu, Hangzhou (CN); Xiyun Wang, Hangzhou (CN)

(73) Assignee: Zhejiang University, Hangzhou, ZJ (CN)

(21) Appl. No.: 19/315,370

(22) Filed: Aug. 29, 2025

(30) Foreign Application Priority Data
May 9, 2025 (CN) 202510593627.0

(51) Int. Cl. G06F 30/327; G06F 30/27; G06F 119/06

(52) U.S. Cl. CPC G06F 30/327; G06F 30/27; G06F 2119/06

(57) ABSTRACT

A method for estimating circuit parameters of DAB converters based on a physics-informed neural network is disclosed, and belongs to the field of circuit parameter estimation technology. By inputting a small amount of inductor current and output voltage data from the DAB converter, the above method is used to achieve high-precision circuit parameter estimation with strong robustness and good generalization capability, with the impact of noise and different modulation strategies on the estimation accuracy taken into consideration.

### TECHNICAL FIELD

The present disclosure relates to the field of circuit parameter estimation technology, particularly to a method for estimating circuit parameters of Dual-Active-Bridge (DAB) converters based on a physics-informed neural network (PINN).

### BACKGROUND

DAB converters have gained significant attention due to their high power density, galvanic isolation, and bidirectional power transfer capabilities. They are widely applied in electrified transportation, distributed generation, and aerospace fields. Furthermore, control optimization and condition monitoring for DAB converters can significantly enhance system efficiency, reduce hardware costs, and mitigate fault risks. To achieve efficient control optimization and precise condition monitoring, accurate parameter estimation of DAB converters is particularly crucial.

Conventional converter parameter estimation methods primarily rely on physical information, which requires additional sensors and complex mathematical calculations. When the system model order is excessively high, the extreme model complexity inevitably leads to heavy computational burdens. In recent years, data-driven parameter estimation methods utilizing Artificial Intelligence (AI) tools have been widely adopted. Nevertheless, these methods require large amounts of data to approximate potential mappings between inputs (voltage and current signals) and outputs (parameters to be estimated), resulting in poor practicality in data-sparse fields such as power electronics.

In the prior art, a method for parameter estimation of Buck converters (step-down converters) based on PINNs has been proposed. This method configures the PINN by sequentially concatenating a data-driven network composed of a fully connected neural network and a physics-informed network governed by the Runge-Kutta method, enabling the estimation of key parameters of Buck converters. The limitations include: applicability only to scenarios with under-tuned proportional-integral (PI) controllers, which contradicts the efficient operation of power converters. Additionally, the topology and operational principles of Buck converters are relatively simple, which makes the implementation of parameter estimation methods easier.

Another prior art method involves estimating direct current (DC)-side capacitance and alternating current (AC)-side inductances of three-phase inverters based on the PINN. The limitations include: hardware experiments indicate that the maximum estimation error for AC-side inductance exceeds 14%, and the maximum estimation error for DC-side capacitance exceeds 5%, demonstrating a low estimation accuracy.

A further prior art method employs genetic algorithm backpropagation (GA-BP) to approximate the mapping between terminal voltages, terminal currents, and circuit parameters of DAB converters. The limitations include: being a purely data-driven method, requiring extensive training data to achieve accurate relationships, and suffering from overfitting risks, high data demands, poor generalization capability, and limited local deployment capability.

Currently, there is no PINN-based parameter estimation method suitable for complex DC-AC-AC-DC systems (such as DAB converters) with only inductor current and output voltage signals being sampled. Moreover, most existing neural network-based parameter estimation methods are only applicable to specific converters with particular control or modulation strategies, exhibiting generalization limitations that hinder their practical application in practical scenarios.

### SUMMARY

An objective of the present disclosure is to provide a method for estimating circuit parameters of DAB converters based on a physics-informed neural network to solve the aforementioned technical problems.

In order to achieve the above objective, the present disclosure provides a method for estimating circuit parameters of DAB converters based on the physics-informed neural network, including the following specific steps:
step S1: deriving time-domain differential equations of the DAB converter;
step S2: defining a dataset of collected power signals information and a dataset of parameters to be estimated, and establishing the physical connection between power signals and the parameters of these two datasets, respectively.
step S3: establishing time-domain recursive relationships based on the physical connection established in step S2; and
step S4: configuring and training a PINN for DAB converter parameter estimation by combining data mechanism and physical information, wherein the PINN updates circuit parameters as weights and biases of the PINN by mapping the predicted power signals information to the collected power signals information, resulting in simultaneous power signals information prediction and parameter estimation.

In some embodiments, when a product of a bridge voltage of the primary side bridge and a bridge voltage of the secondary side bridge of the converter is greater than zero and less than zero will occur within a switching period, the time-domain differential equations of the DAB converter are established as follows:

$$[ \begin{matrix}\frac{{di}_{L}}{dt} \\ \frac{{dv}_{ceq}}{dt} \\ {v}_{oeq}\end{matrix} ] = [ \begin{matrix}- \frac{{R}_{eq} ( {R}_{ceq} + {R}_{oeq} ) + {R}_{ceq} {R}_{oeq}}{L ( {R}_{ceq} + {R}_{oeq} )} & \frac{( 2 S - 1 ) {R}_{oeq}}{L ( {R}_{ceq} + {R}_{oeq} )} \\ \frac{( 1 - 2 S ) {R}_{oeq}}{{C}_{eq} ( {R}_{ceq} + {R}_{oeq} )} & - \frac{1}{{C}_{eq} ( {R}_{ceq} + {R}_{oeq} )} \\ \frac{( 1 - 2 S ) {R}_{oeq} {R}_{ceq}}{{R}_{ceq} + {R}_{oeq}} & \frac{{R}_{oeq}}{{R}_{ceq} + {R}_{oeq}}\end{matrix} ] \times [ \begin{matrix}{i}_{L} \\ {v}_{ceq}\end{matrix} ] + [ \begin{matrix}\frac{{V}_{in}}{L} \\ 0 \\ 0\end{matrix} ] ;$$

where i_{L} is an inductor current, v_{ceq} and v_{oeq} are an equivalent voltage of an output capacitor voltage and an equivalent voltage of an output voltage, respectively; v_{ceq}=nv_{c}, v_{c} is an output capacitor voltage, n is a primary-secondary turns ratio of the transformer; v_{oeq}=nvₒ, vₒ is an output voltage, t represents time;
Vᵢₙ is an input voltage; L is an inductor; S is a state variable of primary and secondary switches, when v_{ab}×v_{cd}>0, S=1; when v_{ab}×v_{cd}<0, S=0, v_{ab} and v_{cd} are the bridge voltages of H₁ and H₂ bridges, respectively;
R_{eq}=R_{L}+2R_{S}+2n²R_{S}, R_{eq} is an equivalent parameter of the inductor parasitic resistance and the switching resistance, R_{L} is a parasitic resistance of the inductor, and R_{S} is an on-state resistance of the power switches;
R_{ceq}=n²R_{C}, R_{ceq} is an equivalent parameter of output capacitor parasitic resistance, and R_{C} is a parasitic resistance of the output capacitor;
R_{oeq}=n²Rₒ, R_{oeq} is an equivalent parameter of the output resistance, and Rₒ is a load resistance;
C_{eq}=n²C, C_{eq} is an equivalent parameter of the output capacitance, and C is an output capacitance.

In some embodiments, step S2 is specifically as follows:
elements in the dataset of collected power signals information include an inductor current and an output voltage;
the dataset of parameters to be estimated is λ={R_{eq}, R_{ceq}, L, C_{eq}>R_{oeq}, Vᵢₙ};
when the inductor current is configured as an input variable, a differential relationship is as follows:

$$\frac{{di}_{L}}{dt} + N [ {i}_{L} ; λ ] = 0 ;$$

where N [i_{L};λ] is a nonlinear operator of the inductor current determined by λ, and the equation is as follows:

$$N [ {i}_{L} ; λ ] = \frac{- {V}_{in} - ( 2 S - 1 ) {v}_{oeq} + {i}_{L} {R}_{eq}}{L} ;$$

when the output voltage is configured as an input variable, a differential relationship is as follows:

$$\frac{{dv}_{oeq}}{dt} + N [ {v}_{oeq} ; λ ] = 0 ;$$

where N [v_{oeq}; λ] is a nonlinear operator of the equivalent output voltage determined λ, and the equation is as follows:

$$N [ {v}_{oeq} ; λ ] = \frac{{v}_{oeq} - ( 1 - 2 S ) {R}_{oeq} ( {i}_{L} + {R}_{{C}_{oeq}} {C}_{oeq} N [ {i}_{L} , λ ] )}{( {R}_{oeq} + {R}_{{C}_{oeq}} ) {C}_{oeq}} .$$

In some embodiments, step S3 is specifically as follows:
step S31: assuming that at an initial time instant tₙ and a final time instant tₙ₊₁ with tₙ₊₁=tₙ+Δt; the inductor current initial and final states are i_{L}(tₙ) and i_{L}(tₙ₊₁), respectively, the output voltage initial and final states are v_{oeq}(tₙ) and v_{oeq}(tₙ₊₁), respectively, and assuming there are q unobservable intermediate states within a time period Δt, where the intermediate states are: i_{L}(t_{n+ci}), v_{oeq}(t_{+ci}), t_{n+ci}=tₙ+cᵢΔt, where cᵢ is a time coefficient, 0<cᵢ<1, i=1, . . . , q, and an intermediate state point i_{L}(t_{n+ci}) and an intermediate state point v_{oeq}(t_{n+ci}) are implicit points;
step S32: using half of the switching period as the measurement interval and referencing the inductor current waveform, setting the initial time instant tₙ as the first inflection point of the inductor current waveform. Then, determining a random time instant within a specified threshold around the midpoint between the second and third inflection points, which is also selected as the initial time instant. Regarding the point corresponding to the random time instant as a quasi-midpoint. Selecting the final time instants tₙ₊₁ as the second and third inflection point time instants. Thus, for the inductor current and the output voltage, the initial time instants tₙ correspond to i_{L}(tₙ) and v_{oeq}(tₙ), respectively, the final time instants tₙ₊₁ correspond to i_{L}(tₙ₊₁) and v_{oeq}(tₙ₊₁), respectively, with points corresponding to the initial time instants tₙ and the final time instants tₙ₊₁ being explicit points; and
step S33: using a q-order implicit Runge-Kutta method to couple implicit points and explicit points, and a constant parameter set {aᵢⱼ,bⱼ,cᵢ} determined by the order q, where aᵢⱼ and bⱼ are relation constants, and cᵢ is the time coefficient constant from step S31;
establishing a forward recursive relationship and a backward recursive relationship for both inductor current and equivalent output voltage to couple explicit points and implicit points;
the backward recursive relationship equations are as follows:

$$\{ \begin{matrix}{i}_{L} ( {t}_{n} ) = {i}_{L} ( {t}_{n + {c}_{i}} ) + Δt {\sum }_{j = 1}^{q} {a}_{ij} N [ {i}_{L} ( {t}_{n + {c}_{i}} ) ; λ ] \\ {v}_{oeq} ( {t}_{n} ) = {v}_{oeq} ( {t}_{n + {c}_{i}} ) + Δt {\sum }_{j = 1}^{q} {a}_{ij} N [ {v}_{oeq} ( {t}_{n + {c}_{i}} ) ; λ ]\end{matrix} ;$$

the forward recursive relationship equations are as follows:

$$\{ \begin{matrix}{i}_{L} ( {t}_{n + 1} ) = {i}_{L} ( {t}_{n} ) + Δt {\sum }_{j = 1}^{q} ( {a}_{ij} - {b}_{j} ) N [ {i}_{L} ( {t}_{n + {c}_{i}} ) ; λ ] \\ {v}_{o e q} ( {t}_{n + 1} ) = {v}_{o e q} ( {t}_{n} ) + Δt {\sum }_{j = 1}^{q} ( {a}_{ij} - {b}_{j} ) N [ {v}_{oeq} ( {t}_{n + {c}_{i}} ) ; λ ]\end{matrix} .$$

In some embodiments, step S4 is specifically as follows:
step S41: defining a fully connected neural network as a data-driven network, with inputs being power signals information i_{L}(tₙ) of the explicit point corresponding to the initial time instants, power signals information v_{oeq}(tₙ) of the explicit point corresponding to the initial time instants, state variables S, and time intervals Δt between the initial time instants and the final time instants, biases and weights being {w,b}, and outputs being predicted power signals information i_{L}(t_{n+ci}) and v_{oeq}(t_{n+ci}), i.e., the implicit points;
step S42: establishing a physics-informed network based on the backward recursive relationship equations and forward recursive relationship equations, with inputs being implicit points i_{L}(t_{n+ci}) and v_{oeq}(t_{n+ci}), biases and weights being λ, and outputs being predicted power signals information i_{L}*(tₙ), i_{L}*(tₙ₊₁), v_{oeq}*(tₙ) and v_{oeq}*(tₙ₊₁), i.e., the explicit points,
step S43: concatenating the data-driven network and physics-informed network in series to form the PINN for DAB converter parameter estimation by combining data mechanism and physical information;
step S44: through simulations and experiments, collecting the power signals information of the DAB converter according to step S3 to form the dataset of collected power signals information for the PINN, when collecting the simulation data, adding cases with analog-to-digital conversion noise and sampling noise to the data, as well as cases using a single-phase-shift modulation and a dual-phase-shift modulation; and
step S45: determining a loss function and early stopping criteria to train the PINN for DAB converter parameter estimation in step S43. When the early stopping criteria are met, outputting the estimated parameters.

In some embodiments, in step S45, the loss function equation is as follows:

$$L ( Λ ) = {\sum }_{n} [ {( {i}_{L} * ( {t}_{n} ) - {i}_{L} ( {t}_{n} ) )}^{2} + {( {i}_{L} * ( {t}_{n + 1} ) - {i}_{L} ( {t}_{n + 1} ) )}^{2} + {( {v}_{oeq} * ( {t}_{n} ) - {v}_{oeq} ( {t}_{n} ) )}^{2} + {( {v}_{o e q} * ( {t}_{n + 1} ) - {v}_{oeq} ( {t}_{n + 1} ) )}^{2} ]$$

where L(Λ) is a loss function, i_{L}*(tₙ) and i_{L}*(tₙ₊₁) are inductor current predicted values at the initial time instants tₙ and the final time instants tₙ₊₁, respectively, v_{oeq}*(tₙ) and v_{oeq}*(tₙ₊₁) are output voltage predicted values at the initial time instants tₙ and the final time instants tₙ₊₁, respectively;
the early stopping criteria are as follows:
when a training cycle reaches a first set number, L(Λ)<1, or L(Λ)<2 for two consecutive times;
or the training cycle reaches a second set number.

Therefore, the present disclosure adopts the above-mentioned method for estimating circuit parameters of DAB converters based on physics-informed neural network, which provides the following beneficial effects:

(1) A PINN is constructed for DAB by combining data mechanism and physical information. High-precision circuit parameter estimation is achieved through inputting a small amount of key data including the inductor current and output voltage of the DAB converter.

(2) When considering the impact of analog-to-digital conversion noise and sampling noise on the accuracy of collected data, the accuracy of the estimation results is minimally affected, demonstrating strong robustness.

(3) The parameters can be accurately estimated under both single-phase-shift modulation and dual-phase-shift modulation strategies, exhibiting excellent generalization capability over different modulation strategies.

Further detailed descriptions of the technical scheme of the present disclosure can be found in the accompanying drawings and embodiments.

### BRIEF DESCRIPTION OF THE DRAWINGS

FIG. 1 is a flowchart of a method for estimating circuit parameters of DAB converters based on a physics-informed neural network according to the present disclosure;

FIG. 2 is an application diagram of an embodiment of the present disclosure;

FIG. 3 is a circuit topology diagram of a DAB converter adopted in the present disclosure;

FIG. 4 is an equivalent circuit diagram of a DAB converter adopted in the present disclosure;

FIG. 5 is a schematic diagram of explicit initial points, explicit final points and implicit points selected in the present disclosure represented by the waveforms of the inductor current;

FIG. 6 is a structural diagram of a physics-informed neural network constructed in the present disclosure;

FIG. 7 is a convergence process diagram of a physics-informed neural network of the present disclosure;

FIG. 8 is a comparison diagram of experimental waveforms, simulation waveforms and predicted points of inductor current according to the scheme provided in the present disclosure;

FIG. 9 is a comparison diagram of experimental waveforms, simulation waveforms and predicted points of output voltage according to the scheme provided in the present disclosure.

### DETAILED DESCRIPTION OF THE EMBODIMENTS

In the above description of the present disclosure, it is to be noted that the orientation or positional relationship indicated by terms “up”, “down”, “inner”, “outer”, etc. is based on the orientation or positional relationship shown in the accompanying drawings, or the orientation or positional relationship of a product conventionally placed during use, merely for ease of description and simplification of the description of the present disclosure, and not to indicate or imply that the referenced device or element must have a particular orientation and be constructed and operative in a particular orientation, and thus may not be construed as a limitation on the present disclosure. In the description of the present disclosure, it should be further noted that, unless otherwise explicitly specified and defined, the terms “arrangement”, “mounting” and “connection” should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. For those of ordinary skill in the art, the specific meanings of the above terms in the present disclosure may be understood according to specific circumstances.

The following is a detailed description of the embodiments of the present disclosure with reference to the accompanying drawings.

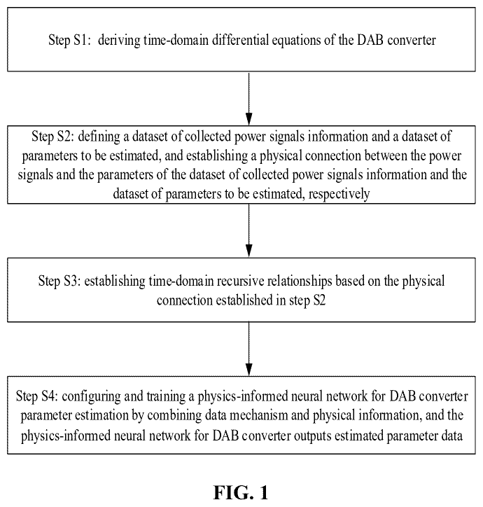

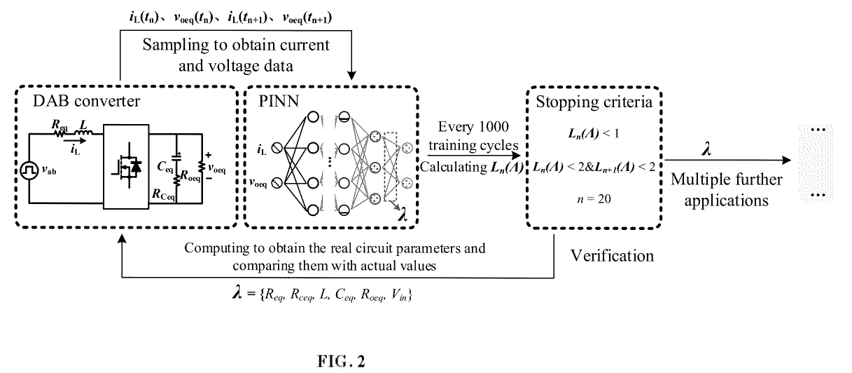

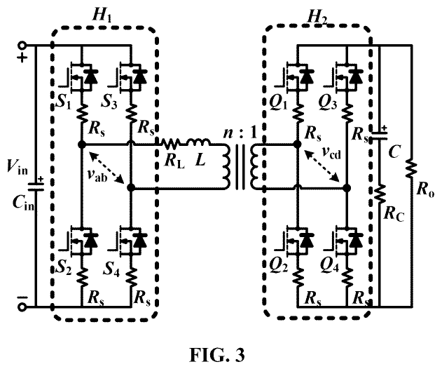

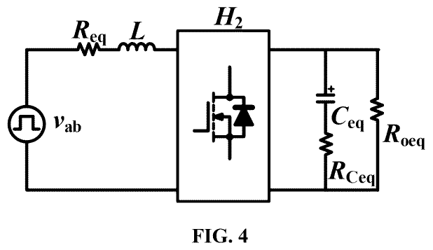

As shown in FIGS. 1-2, a method for estimating circuit parameters of DAB converters based on physics-informed neural network, including the following specific steps:
step S1: the time-domain differential equations of the DAB converter are derived;
when the product of the bridge voltage of the primary side bridge and a bridge voltage of the secondary side bridge of the converter is greater than zero and less than zero will occur within a switching period, for a conventional DAB converter, as shown in FIG. 3, an equivalent is performed, as shown in FIG. 4, the time-domain differential equations of the DAB converter can be established as follows:

$$[ \begin{matrix}\frac{{di}_{L}}{dt} \\ \frac{{dv}_{ceq}}{dt} \\ {v}_{oeq}\end{matrix} ] = [ \begin{matrix}- \frac{{R}_{eq} ( {R}_{ceq} + {R}_{oeq} ) + {R}_{ceq} {R}_{oeq}}{L ( {R}_{ceq} + {R}_{oeq} )} & \frac{( 2 S - 1 ) {R}_{oeq}}{L ( {R}_{ceq} + {R}_{oeq} )} \\ \frac{( 1 - 2 S ) {R}_{oeq}}{{C}_{eq} ( {R}_{ceq} + {R}_{oeq} )} & - \frac{1}{{C}_{eq} ( {R}_{ceq} + {R}_{oeq} )} \\ \frac{( 1 - 2 S ) {R}_{oeq} {R}_{ceq}}{{R}_{ceq} + {R}_{oeq}} & \frac{{R}_{oeq}}{{R}_{ceq} + {R}_{oeq}}\end{matrix} ] \times [ \begin{matrix}{i}_{L} \\ {v}_{ceq}\end{matrix} ] + [ \begin{matrix}\frac{{V}_{in}}{L} \\ 0 \\ 0\end{matrix} ] ;$$

where i_{L} is the inductor current, v_{ceq} and v_{oeq} are the equivalent voltage of the output capacitor voltage and the equivalent voltage of the output voltage, respectively; v_{ceq}=nv_{c}, v_{c} is the output capacitor voltage, n is the primary-secondary turns ratio of the transformer; v_{oeq}=nvₒ, vₒ is the output voltage, t represents time. Vᵢₙ is the input voltage; L is the inductor; S is the state variable of primary and secondary switches, when v_{ab}×v_{cd}>0, S=1; when v_{ab}×v_{cd}<0, S=0, v_{ab} and v_{cd} are the bridge voltages of H₁ and H₂ bridges, respectively. R_{eq}=R_{L}+2R_{S}+2n²R_{S}, R_{eq} is the equivalent parameter of the inductor parasitic resistance and the switching resistance, R_{L} is the parasitic resistance of the inductor, R_{S} is the on-state resistance of the power switches. R_{ceq}=n²R_{C}, R_{ceq} is the equivalent parameter of the output capacitor parasitic resistance, and R_{C} is the parasitic resistance of the output capacitor. R_{oeq}=n²Rₒ, R_{oeq} is the equivalent parameter of the output resistance, and Rₒ is the load resistance. C_{eq}=n²C, C_{eq} is the equivalent parameter of the output capacitance, and C is the output capacitance. Under any specific modulation strategy, including double-phase-shift modulation strategy and single-phase-shift modulation strategy, the time domain equations can be established whenever v_{ab}×v_{cd}>0 and v_{ab}×v_{cd}<0 occur simultaneously in one switching period.

Step S2: the dataset of collected power signals information and the dataset of parameters to be estimated are defined, and the physical connection is established between power signals and the parameters of these two datasets, respectively.

Elements in the dataset of collected power signals information include the inductor current and the output voltage. The dataset of parameters to be estimated is λ={R_{eq}, R_{ceq}, L, C_{eq}, R_{oeq}, Vᵢₙ}.

When the inductor current is configured as the input variable, the differential relationship is as follows:

$$\frac{{di}_{L}}{dt} + N [ {i}_{L} ; λ ] = 0 ;$$

where N[i_{L}; λ] is the nonlinear operator of the inductor current determined by λ, and the equation is as follows:

$$N [ {i}_{L} ; λ ] = \frac{- {V}_{in} - ( 2 S - 1 ) {v}_{oeq} + {i}_{L} {R}_{eq}}{L} ;$$

when the output voltage is configured as the input variable, the differential relationship is as follows:

$$\frac{{d v}_{oeq}}{dt} + N [ {v}_{oeq} ; λ ] = 0 ;$$

where N[v_{oeq}; λ] is the nonlinear operator of the equivalent output voltage determined by λ, and the equation is as follows:

$$N [ {v}_{oeq} ; λ ] = \frac{{v}_{oeq} - ( 1 - 2 S ) {R}_{oeq} ( {i}_{L} + {R}_{{C}_{oeq}} {C}_{oeq} N [ {i}_{L} ; λ ] )}{( {R}_{oeq} + {R}_{{C}_{oeq}} ) {C}_{oeq}} .$$

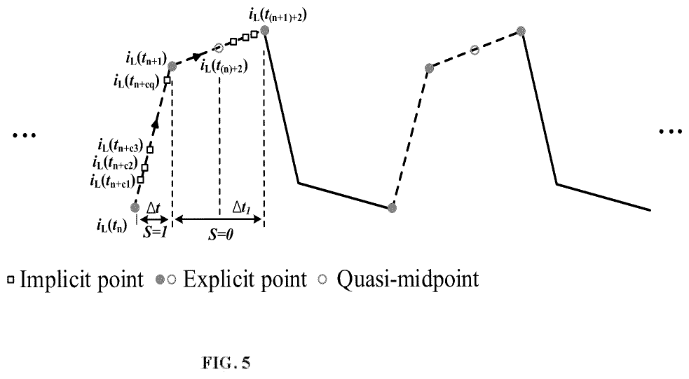

Step S3: the time-domain recursive relationships are established based on the physical connection established in step S2;
step S3 is specifically as follows:
Step S31: assumed that at the initial time instant tₙ and the final time instant tₙ₊₁ with tₙ₊₁=tₙ+Δt; the inductor current initial and final states are i_{L}(tₙ) and i_{L}(tₙ₊₁), respectively, the output voltage initial and final states are v_{oeq}(tₙ) and v_{oeq}(tₙ₊₁), respectively, and assumed there are q unobservable intermediate states within the time period Δt, where the intermediate states are: i_{L}(t_{n+ci}), v_{oeq}(t_{n+ci}), t_{n+ci}=tₙ+cᵢΔt, where cᵢ is the time coefficient, 0≤cᵢ<1, i=1, . . . , q, and the intermediate state point i_{L}(t_{n+ci}) and the intermediate state point v_{oeq}(t_{n+ci}) are implicit points, as shown by the inductor current in FIG. 5.

Step S32: half of the switching period is used as the measurement interval and the inductor current waveform is referenced, the initial time instant tₙ is set as the first inflection point time of inductor current waveform. Then, the random time instant within a specified threshold is determined around the midpoint between the second and third inflection points, which is also selected as the initial time instant. The point corresponding to the random time instant is regarded as the quasi-midpoint. The final time instants tₙ₊₁ are selected as the second and the third inflection point time instants. Thus, for the inductor current and the output voltage, the initial time instants tₙ correspond to i_{L}(tₙ) and v_{oeq}(tₙ), respectively, the final time instants tₙ₊₁ correspond to i_{L}(tₙ₊₁) and v_{oeq}(tₙ₊₁), respectively, with the points corresponding to the initial time instants tₙ and the final time instants tₙ₊₁ are explicit points, as shown by the inductor current in FIG. 5.

Step S33: the q-order implicit Runge-Kutta method is used to couple implicit points and explicit points, the constant parameter set {aᵢⱼ, bⱼ, cᵢ} determined by the order q, where aᵢⱼ and bⱼ are relation constants, and cᵢ is the time coefficient constant from step S31. The order q of the Runge-Kutta method in the PINN is not fixed and may be adjusted according to practical estimation requirements. A 10th-order Runge-Kutta method is selected in this context.

The forward recursive relationship and the backward recursive relationship for both inductor current and equivalent output voltage are established to couple explicit points and implicit points.

The backward recursive relationship equations are as follows:

$$\{ \begin{matrix}{i}_{L} ( {t}_{n} ) = {i}_{L} ( {t}_{n + {c}_{i}} ) + Δ t {\sum }_{j = 1}^{q} {a}_{ij} N [ {i}_{L} ( {t}_{n + {c}_{i}} ) ; λ ] \\ {v}_{oeq} ( {t}_{n} ) = {v}_{oeq} ( {t}_{n + {c}_{i}} ) + Δ t {\sum }_{j = 1}^{q} {a}_{ij} N [ {v}_{oeq} ( {t}_{n + {c}_{i}} ) ; λ ]\end{matrix} ;$$

the forward recursive relationship equations are as follows:

$$\{ \begin{matrix}{i}_{L} ( {t}_{n + 1} ) = {i}_{L} ( {t}_{n} ) + Δ t {\sum }_{j = 1}^{q} ( {a}_{ij} - {b}_{j} ) N [ {i}_{L} ( {t}_{n + {c}_{i}} ) ; λ ] \\ {v}_{oeq} ( {t}_{n + 1} ) = {v}_{oeq} ( {t}_{n} ) + Δ t {\sum }_{j = 1}^{q} ( {a}_{ij} - {b}_{j} ) N [ {v}_{oeq} ( {t}_{n + {c}_{i}} ) ; λ ]\end{matrix} .$$

The forward recursive relationship and the backward recursive relationship lay the foundation for the subsequent establishment of the physics-informed network part.

Step S4: the PINN for DAB converter parameter estimation by combining the data mechanism and physical information is configured and trained, wherein the PINN updates circuit parameters as weights and biases of the PINN by mapping the predicted power signals information to the collected power signals information, resulting in simultaneous power signals information prediction and parameter estimation.

Step S4 is specifically as follows:
step S41: the data-driven fully connected neural network is defined as the data-driven network, with inputs being power signals information i_{L}(tₙ) of the explicit point corresponding to the initial time instants, power signals information v_{oeq}(tₙ) of the explicit point corresponding to the initial time instants, state variable S, and the time interval Δt between the initial time instant and the final time instant, biases and weights being {w,b}, and outputs being predicted power signals information i_{L}(t_{n+ci}) and v_{oeq}(t_{n+ci}), i.e., the implicit points;
step S42: the physics-informed network is established based on the backward recursive relationship equations and forward recursive relationship equations, with inputs being implicit points i_{L}(t_{n+ci}) and v_{oeq}(t_{n+ci}), biases and weights being λ, and outputs being predicted power signals information i_{L}*(tₙ), i_{L}*(tₙ₊₁), v_{oeq}*(tₙ) and v_{oeq}*(tₙ₊₁), i.e., the explicit points,

The structure of the data-driven neural network is not fixed, and the number of hidden layers and the number of neurons per layer may be adjusted according to practical estimation requirements. In this context, the selected data-driven network is a fully connected neural network with 4 hidden layers containing 50 neurons, and its activation functions are Leaky ReLU and tanh functions, with biases and weights being {w,b}.

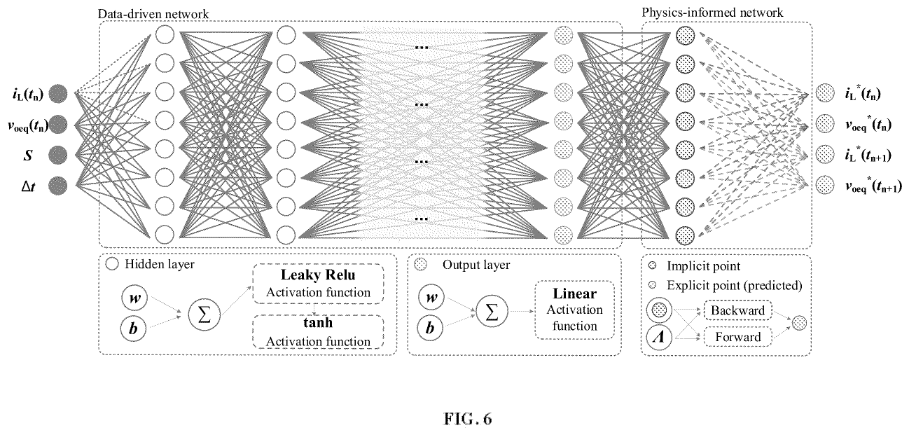

Step S43: the data-driven network and physics-informed network are concatenated in series to form the PINN for DAB converter parameter estimation by combining data mechanism and physical information, as shown in FIG. 6.

Step S44: through the simulations and experiments, the power signals information of the DAB converter is collected according to step S3 to form the dataset of collected power signals information for the PINN. When collecting the simulation data, the cases with analog-to-digital conversion noise and sampling noise are added to the data, as well as cases using the single-phase-shift modulation and the dual-phase-shift modulation are added. In the embodiment, the single-phase-shift modulation is used to control the converter in the experiment.

Step S45: the loss function and early stopping criteria are determined to train the PINN for DAB converter parameter estimation in step S43. When the early stopping criteria are met, the estimated parameters are output.

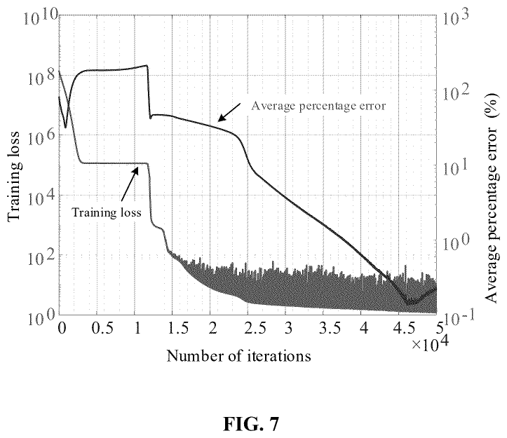

In step S45, the loss function equation is as follows:

$$L ( Λ ) = {\sum }_{n} [ {( {i}_{L} * ( {t}_{n} ) - {i}_{L} ( {t}_{n} ) )}^{2} + {( {i}_{L} * ( {t}_{n + 1} ) - {i}_{L} ( {t}_{n + 1} ) )}^{2} + {( {v}_{oeq} * ( {t}_{n} ) - {v}_{oeq} ( {t}_{n} ) )}^{2} + {( {v}_{oeq} * ( {t}_{n + 1} ) - {v}_{oeq} ( {t}_{n + 1} ) )}^{2} ]$$

where L(Λ) is the loss function, Λ={w, b, λ}, the PINN reduces the L(Λ) of the loss function by continuously updating Λ, i.e., updating {w,b} and λ, which affect the convergence process of the data-driven network and the physics-informed network, respectively, thereby promoting the convergence of the predicted points to the actual value, as shown in FIG. 7. i_{L}*(tₙ) and i_{L}*(tₙ₊₁) are inductor current predicted values at the initial time instants tₙ and the final time instants tₙ₊₁, respectively, v_{oeq}*(tₙ) and v_{oeq}*(tₙ₊₁) are output voltage predicted values at the initial time instants tₙ and the final time instants tₙ₊₁, respectively.

The early stopping criteria are as follows:
when the training cycle reaches the first set number, the first set number of this embodiment is 1000, L(Λ)<1, or L(Λ)<2 for two consecutive times;
or the training cycle reaches the second set number, and the second set number is 20000.

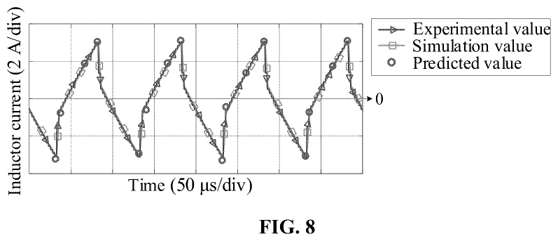

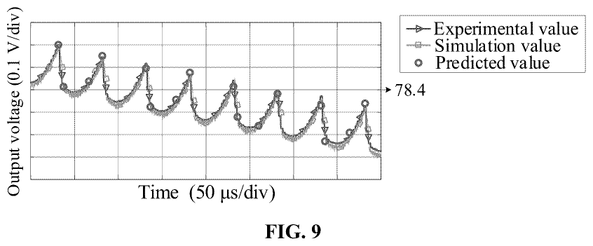

After the above stop conditions are reached, the final λ is output, which is the final unknown dataset of parameters to be estimated. The comparison diagrams of experimental waveforms, simulation waveforms and predicted points is shown in FIGS. 8-9. In all simulation examples, the average percentage error of the estimated parameters is less than or equal to 1.5%. In experiments conducted on a hardware-in-the-loop platform, the average percentage error of all estimated parameters is less than or equal to 6.8%, which verifies the effectiveness and accuracy of the aforementioned method.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method for estimating circuit parameters of DAB converters based on a physics-informed neural network (PINN), comprising the following specific steps:
step S1: deriving time-domain differential equations of a DAB converter;
step S2: defining a dataset of collected power signals information and a dataset of parameters to be estimated, and establishing a physical connection between the power signals and the parameters of the dataset of collected power signals information and the dataset of parameters to be estimated, respectively;
step S3: establishing time-domain recursive relationships based on the physical connection established in step S2; and
step S4: configuring and training a PINN for DAB converter parameter estimation by combining a data mechanism and physical information, wherein the PINN updates circuit parameters as weights and biases of the PINN by mapping the predicted power signals information to the collected power signals information, resulting in simultaneous power signals information prediction and parameter data estimation.

2. The method for estimating circuit parameters of DAB converters based on the physics-informed neural network according to claim 1, wherein when a product of a bridge voltage of the primary side bridge and a bridge voltage of the secondary side bridge of the converter is greater than zero and less than zero will occur within a switching period, the time-domain differential equations of the DAB converter are established as follows:
$$[ \begin{matrix}\frac{{di}_{L}}{dt} \\ \frac{{d v}_{ceq}}{dt} \\ {v}_{oeq}\end{matrix} ] = [ \begin{matrix}- \frac{{R}_{eq} ( {R}_{ceq} + {R}_{oeq} ) + {R}_{ceq} {R}_{oeq}}{L ( {R}_{ceq} + {R}_{oeq} )} & \frac{( 2 S - 1 ) {R}_{oeq}}{L ( {R}_{ceq} + {R}_{oeq} )} \\ \frac{( 1 - 2 S ) {R}_{oeq}}{{C}_{eq} ( {R}_{ceq} + {R}_{oeq} )} & - \frac{1}{{C}_{eq} ( {R}_{ceq} + {R}_{oeq} )} \\ \frac{( 1 - 2 S ) {R}_{oeq} {R}_{ceq}}{{R}_{ceq} + {R}_{oeq}} & \frac{{R}_{oeq}}{{R}_{ceq} + {R}_{oeq}}\end{matrix} ] \times [ \begin{matrix}{i}_{L} \\ {v}_{ceq}\end{matrix} ] + [ \begin{matrix}\frac{{V}_{in}}{L} \\ 0 \\ 0\end{matrix} ] ;$$
where it is an inductor current, v_{ceq} and v_{oeq} are an equivalent voltage of an output capacitor voltage and an equivalent voltage of an output voltage, respectively; v_{ceq}=nv_{c}, v_{c} is an output capacitor voltage, n is a primary-secondary turns ratio of the transformer; v_{oeq}=nvₒ, vₒ is an output voltage, t represents time;
Vᵢₙ is an input voltage; L is an inductor; S is a state variable of primary and secondary switches, when v_{ab}×v_{cd}>0, S=1; when v_{ab}×v_{cd}<0, S=0, v_{ab} and v_{cd} are bridge voltages of H₁ and H₂ bridges, respectively;
R_{eq}=R_{L}+2R_{S}+2n²R_{S}, R_{eq} is an equivalent parameter of the inductor parasitic resistance and the switching resistance, R_{L} is a parasitic resistance of the inductor, and R_{S} is an on-state conduction resistance of the power switches;
R_{ceq}=n²R_{C}, R_{ceq} is an equivalent parameter of output capacitor parasitic resistance, and R_{C} is a parasitic resistance of the output capacitor;
R_{oeq}=n²Rₒ, R_{oeq} is an equivalent parameter of the output resistance, and Rₒ is a load resistance; and
C_{eq}=n²C, C_{eq} is an equivalent parameter of the output capacitance, and C is an output capacitance.

3. The method for estimating circuit parameters of DAB converters based on the physics-informed neural network according to claim 2, wherein step S2 is specifically as follows:
elements in the dataset of collected power signals information comprise an inductor current and an output voltage;
the dataset of parameters to be estimated is λ={R_{eq}, R_{ceq}, L, C_{eq}, R_{oeq}, Vᵢₙ};
when the inductor current is configured as an input variable, a differential relationship is as follows:
$$\frac{{di}_{L}}{dt} + N [ {i}_{L} ; λ ] = 0 ;$$
where N[i_{L}; λ] is a nonlinear operator of the inductor current determined by λ, and the equation is as follows:
$$N [ {i}_{L} ; λ ] = \frac{- {V}_{in} - ( 2 S - 1 ) {v}_{oeq} + {i}_{L} {R}_{eq}}{L} ;$$
when the output voltage is configured as an input variable, a differential relationship is as follows:
$$\frac{{d v}_{oeq}}{dt} + N [ {v}_{oeq} ; λ ] = 0 ;$$
where N[v_{oeq}; λ] is a nonlinear operator of the equivalent output voltage determined by λ, and the equation is as follows:
$$N [ {v}_{oeq} ; λ ] = \frac{{v}_{oeq} - ( 1 - 2 S ) {R}_{oeq} ( {i}_{L} + {R}_{{C}_{oeq}} {C}_{oeq} N [ {i}_{L} ; λ ] )}{( {R}_{oeq} + {R}_{{C}_{oeq}} ) {C}_{oeq}} .$$

4. The method for estimating circuit parameters of DAB converters based on the physics-informed neural network according to claim 2, wherein step S3 is specifically as follows:
step S31: assuming that at an initial time instant tₙ and a final time instant tₙ₊₁ with tₙ₊₁=tₙ+Δt; the inductor current initial and final states are i_{L}(tₙ) and i_{L}(tₙ₊₁), respectively, the output voltage initial and final states are v_{oeq}(tₙ) and v_{oeq}(tₙ₊₁), respectively, and assuming there are q unobservable intermediate states within a time period Δt, where the intermediate states are: i_{L}(t_{n+ci}), v_{oeq}(t_{n+ci}), t_{n+ci}=cᵢΔt, where cᵢ is a time coefficient, 0≤cᵢ<1, i=1, . . . , q, and an intermediate state point i_{L}(t_{n+ci}) and an intermediate state point v_{oeq}(t_{n+ci}) are implicit points;
step S32: using half of the switching period as a measurement interval and referencing the inductor current waveform, setting the initial time instant tₙ as a first inflection point of the inductor current waveform, then, determining a random time instant within a specified threshold around an midpoint between second and third inflection points, which is also selected as the initial time instant, regarding a point corresponding to the random time instant as a quasi-midpoint, and selecting the final time instants tₙ₊₁ as the second and the third inflection point time instants, thus, for the inductor current and the output voltage, the initial time instants tₙ correspond to i_{L}(tₙ) and v_{oeq}(tₙ), respectively, the final time instants tₙ₊₁ correspond to i_{L}(tₙ₊₁) and v_{oeq}(tₙ₊₁), respectively, with points corresponding to the initial time instants tₙ and the final time instants tₙ₊₁ being explicit points; and
step S33: using a q-order implicit Runge-Kutta method to couple implicit points and explicit points, and a constant parameter set {aᵢⱼ, bⱼ, cᵢ} determined by the order q, where aᵢⱼ and bⱼ are relation constants, cᵢ is the time coefficient constant from step S31;
establishing a forward recursive relationship and a backward recursive relationship for both inductor current and equivalent output voltage to couple explicit points and implicit points;
wherein the backward recursive relationship equations are as follows:
$$\{ \begin{matrix}{i}_{L} ( {t}_{n} ) = {i}_{L} ( {t}_{n + {c}_{i}} ) + Δ t {\sum }_{j = 1}^{q} {a}_{ij} N [ {i}_{L} ( {t}_{n + {c}_{i}} ) ; λ ] \\ {v}_{oeq} ( {t}_{n} ) = {v}_{oeq} ( {t}_{n + {c}_{i}} ) + Δ t {\sum }_{j = 1}^{q} {a}_{ij} N [ {v}_{oeq} ( {t}_{n + {c}_{i}} ) ; λ ]\end{matrix} ;$$
wherein the forward recursive relationship equations are as follows:
$$\{ \begin{matrix}{i}_{L} ( {t}_{n + 1} ) = {i}_{L} ( {t}_{n} ) + Δ t {\sum }_{j = 1}^{q} ( {a}_{ij} - {b}_{j} ) N [ {i}_{L} ( {t}_{n + {c}_{i}} ) ; λ ] \\ {v}_{oeq} ( {t}_{n + 1} ) = {v}_{oeq} ( {t}_{n} ) + Δ t {\sum }_{j = 1}^{q} ( {a}_{ij} - {b}_{j} ) N [ {v}_{oeq} ( {t}_{n + {c}_{i}} ) ; λ ]\end{matrix} .$$

5. The method for estimating circuit parameters of DAB converters based on the physics-informed neural network according to claim 2, wherein step S4 is specifically as follows:
step S41: defining a fully connected neural network as a data-driven network, with inputs being power signals information i_{L}(tₙ) of the explicit point corresponding to the initial time instants, power signals information v_{oeq}(tₙ) of the explicit point corresponding to the initial time instants, state variable S, and time interval Δt between the initial time instant and the final time instant, biases and weights being {w,b}, and outputs being predicted power signals information i_{L}(t_{n+ci}) and v_{oeq}(t_{n+ci}), i.e., the implicit points;
step S42: establishing a physics-informed network based on the backward recursive relationship equations and forward recursive relationship equations, with inputs being implicit points i_{L}(t_{n+ci}) and v_{oeq}(t_{n+ci}), biases and weights being 2, and outputs being predicted power signals information i_{L}*(tₙ), i_{L}*(tₙ₊₁), v_{oeq}(tₙ) and v_{oeq}*(tₙ₊₁), i.e., the explicit points;
step S43: concatenating the data-driven network and physics-informed network in series to form the PINN for DAB converter parameter estimation by combining data mechanism and physical information;
step S44: through simulations and experiments, collecting the power signals information of the DAB converter according to step S3 to form the dataset of collected power signals information for the PINN, when collecting the simulation data, adding cases with analog-to-digital conversion noise and sampling noise to the data, as well as cases using a single-phase-shift modulation and a dual-phase-shift modulation; and
step S45: determining a loss function and early stopping criteria to train the PINN for DAB converter parameter estimation in step S43, when the early stopping criteria are met, outputting the estimated parameters.

6. The method for estimating circuit parameters of DAB converters based on the physics-informed neural network according to claim 5, wherein in step S45, the loss function equation is as follows:
$$L ( Λ ) = {\sum }_{n} [ {( {i}_{L} * ( {t}_{n} ) - {i}_{L} ( {t}_{n} ) )}^{2} + {( {i}_{L} * ( {t}_{n + 1} ) - {i}_{L} ( {t}_{n + 1} ) )}^{2} + {( {v}_{oeq} * ( {t}_{n} ) - {v}_{oeq} ( {t}_{n} ) )}^{2} + {( {v}_{oeq} * ( {t}_{n + 1} ) - {v}_{oeq} ( {t}_{n + 1} ) )}^{2} ]$$
where L(Λ) is a loss function, i_{L}*(tₙ) and i_{L}*(tₙ₊₁) are inductor current predicted values at the initial time instants tₙ and the final time instants tₙ₊₁, respectively, v_{oeq}*(tₙ) and v_{oeq}*(tₙ₊₁) are output voltage predicted values at the initial time instants tₙ and the final time instants tₙ₊₁, respectively;
wherein the early stopping criteria are as follows:
when a training cycle reaches a first set number, L(Λ)<1, or L(Λ)<2 for two consecutive times;
or the training cycle reaches a second set number.
